(19) United States
(12) Patent Application Publication
(10) Pub. No.: US 2024/0412049 A1
(43) Pub. Date: Dec. 12, 2024

(54) METHOD, DEVICE AND STORAGE MEDIUM FOR MODEL EVALUATION

(71) Applicants: Beijing Youzhuju Network Technology Co., Ltd., Beijing (CN); Lemon Inc., Grand Cayman (KY)

(72) Inventors: Yukun MA, Vancouver (CA); Arinze OFFOR, Los Angeles, CA (US)

(21) Appl. No.: 18/814,317

(22) Filed: Aug. 23, 2024

(30) Foreign Application Priority Data
Aug. 25, 2023 (CN) 202311090858.7

(51) Int. Cl. G06N 3/0475

(52) U.S. Cl. CPC G06N 3/0475

(57) ABSTRACT

In embodiments of the present disclosure, a solution for model evaluation is provided. The method comprises: providing inputs in an input set to a first generative model, to obtain a first output set output by a first generative model, wherein the first output set comprises a plurality of outputs corresponding to the plurality of inputs; obtaining first labelling information corresponding to a plurality of outputs in the first output set, the first labelling information indicating a quality level of each output marked in a plurality of quality levels divided in each quality evaluation dimension in the plurality of quality evaluation dimensions; and determining a first overall quality score of the first generative model at least based on the first labelling information of the outputs and respective quality scores corresponding to the plurality of quality levels divided in the plurality of quality evaluation dimensions.

### CROSS-REFERENCE

This application claims priority to Chinese Patent Application No. 202311090858.7 filed on Aug. 25, 2023, and entitled “METHOD, APPARATUS, DEVICE AND STORAGE MEDIUM FOR MODEL EVALUATION”, the entirety of which is incorporated herein by reference.

### FIELD

Example embodiments of the present disclosure generally relate to the field of computer technologies, and in particular, to a method, apparatus, device, and computer-readable storage medium for model evaluation.

### BACKGROUND

Machine learning and deep learning techniques have been widely used in various fields. A generative model refers to a model capable of generating a new model output based on a model input in a given modality. The generative model is mainly applied to the fields of natural language processing, machine translation, speech synthesis, image generation and the like, and can be applied to more fields in the future, such as medical, financial, education and the like. For the content output by a generative model, the performance of the model needs to be accurately evaluated.

### SUMMARY

In a first aspect of the present disclosure, a model for model evaluation is provided. The method comprises the following steps: respectively providing a plurality of inputs in an input set to a first generative model, respectively, to obtain a first output set output by a first generative model, wherein the first output set comprises a plurality of outputs respectively corresponding to the plurality of inputs; obtaining first labelling information corresponding to a plurality of outputs in the first output set, wherein the first labelling information indicates a quality level of each output marked in a plurality of quality levels divided in each quality evaluation dimension in the plurality of quality evaluation dimensions; and determining a first overall quality score of the first generative model at least based on the first labelling information of the plurality of outputs in the first output set and the quality scores corresponding to the plurality of quality levels divided in the plurality of quality evaluation dimensions.

In a second aspect of the present disclosure, an apparatus for model evaluation is provided. The apparatus comprises: a first input providing module configured to provide a plurality of inputs in an input set to a first generative model, respectively, to obtain a first output set output by the first generative model, the first output set comprising a plurality of outputs respectively corresponding to the plurality of inputs; a first labelling obtaining module configured to obtain first labelling information for a plurality of outputs in the first output set, the first labelling information indicating a quality level of each output labelled from a plurality of quality levels divided in each quality evaluation dimension of a plurality of quality evaluation dimensions; and a first overall quality determining module configured to determine a first overall quality score of the first generative model based at least on the first labelling information of the plurality of outputs in the first output set and respective quality scores corresponding to the plurality of quality levels divided in the plurality of quality evaluation dimensions.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The medium stores a computer program, and when the computer program is executed by the processor, the method in the first aspect is implemented.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 shows a block diagram of a model evaluation system according to some embodiments of the present disclosure;

FIG. 3 illustrates a comparison diagram of model overall quality scores according to some embodiments of the present disclosure;

FIG. 4 shows a flowchart of a process for model evaluation according to some embodiments of the present disclosure;

FIG. 5 shows a block diagram of an apparatus for model evaluation according to some embodiments of the present disclosure; and

FIG. 6 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “including” and the like should be understood to include “including but not limited to”. The term “based on” should be understood as “based at least on”. The terms “one embodiment” or “the embodiment” should be understood as “at least one embodiment”. The term “some embodiments” should be understood as “at least some embodiments”. Other explicit and implicit clearness may also be included below.

It may be understood that the data involved in the technical solution (including but not limited to the data itself, the obtaining or use of the data) should follow the requirements of the corresponding laws and regulations and related regulations.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the authorization of the user is obtained.

For example, in response to receiving an active request from a user, prompt information is sent to the user to explicitly prompt the user that the requested operation will need to obtain and use personal personal information of the user, so that the user can autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using multi-layer processing unit. The neural network model is one example of a deep learning model. As used herein, a “model” may also be referred to as a “machine learning model,” a “learning model,” a “machine learning network,” or a “learning network,” which terms are used interchangeably herein.

A “neural network” is a deep learning-based machine learning network. The neural network is capable of processing inputs and providing respective outputs, which typically include an input layer, an output layer and one or more hidden layers between the input layer and the output layer. Neural networks used in deep learning applications typically include many hidden layers, increasing the depth of the network. The respective layers of the neural network are connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), each node processing input from the previous layer.

Generally, machine learning may include three stages, a training stage, a testing stage, and an application stage (also referred to as an inference stage). At the training stage, a given model may be trained using a large amount of training data, constantly iteration the parameter values, until the model is able to obtain consistent inferences from the training data that satisfy the expected objectives. By training, the model may be considered to be able to learn from the training data an association from input to output (also referred to as mapping of input to output). The parameter values of the trained model are determined. In the testing stage, the test input is applied to the trained model to test whether the model can provide the correct output, thereby determining the performance of the model. The testing stage may sometimes be fused in a training stage. In the application stage, the trained model may be used to process the real-world model input based on the parameter values obtained by training, to determine a corresponding model output.

A generative model refers to a content generation technique implemented by a model. The generative model may automatically generate, from the input content, meaningful and coherent content, including natural language text, image, audio, video, etc. Under the push of large-scale pretrained model, the generation quality of generative models reach the degree of “writing like human beings” in many applications. Although the generative models have made significant advances in terms of generating content, the objective and effective quality assessment of these generated content remains a key challenge. In many applications, the quality assessment method of generative model is crucial to ensure the accuracy and usability of the generated content.

Current evaluation methods are generally classified into two types of automatic evaluation and manual evaluation. The automatic evaluation method mainly relies on various metrics to evaluate the quality of the generated content. BLEU (Billing Dual Evaluation Understand) is an evaluation metric indicator widely used for machine translation tasks, and mainly measures n-gram overlap between generated content and reference text. ROUGE (Recall-Oriented Understudy for Gisting Evaluation) is a metric index for evaluating an automatic digest task, and mainly calculates an n-gram coincidence degree between the generated content and a reference digest. METEOR (Metric for Evaluation of Translation with Explicit ORderings) is also an evaluation metric index for machine translation, which not only calculates the degree of coincidence between the generated content and the reference text, but also considers the stem and synonyms. Perplexity is an indicator used to measure the prediction capability of the language generative model, and the lower the value is, the more the text generated by the representation model conforms to the grammar rules and actually-used text. Although these indicators may evaluate the quality of the generated text to some extent, they mainly focus on the overlap of the text content, and do not fully consider other aspects such as logic performance and information quality of the generated content. Furthermore, such metrics cannot be extended for non-textual modal content. In terms of manual evaluation, the evaluation personnel may be required to evaluate the quality of the generated content according to predefined evaluation criteria.

As for the generative model, the automatic evaluation method cannot accurately evaluate whether a model is available. Taking the text as an example, the grammar error, the text style, the logic of the text and the text bias in the text output by the model are not covered by the automatic evaluation method. However, if it is purely relied on manual evaluation, there may be a subjective bias problem, resulting in inaccurate model evaluation. Also, there may be no comparability between the evaluation results of different persons on different models.

In embodiments of the present disclosure, an improved solution for model evaluation is proposed. In this solution, on the basis of a reference input set, an output generated by a generative model to be evaluated is determined for each input in the reference input set. Each output generated by the model is labeled in a plurality of predetermined quality evaluation dimensions, with one of the quality levels that are divided for each quality evaluation dimension. Each quality evaluation dimension may be divided into a plurality of quality levels at a granularity. Each quality level has a corresponding quality score. In this way, the overall quality score of the generative model may be determined based on the labelling information of the plurality of outputs and the quality score corresponding to each quality level. The quality of the content generated by the model can be accurately and objectively measured under the same quality evaluation dimension, reference input set and labelling criteria, and thus the qualities of different models is comparable.

Some example embodiments of the present disclosure will be described below with reference to the accompanying drawings.

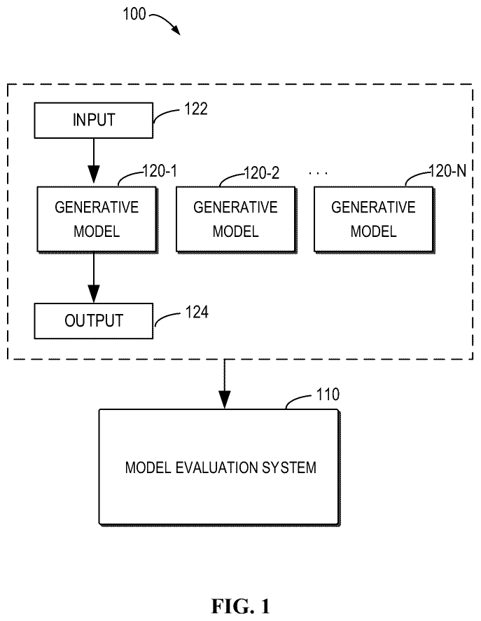

FIG. 1 illustrates a schematic diagram of an example environment 100 in which embodiments of the present disclosure can be implemented. In the environment 100, a model evaluation system 110 is configured to perform model performance evaluation on one or more generative models 120-1, 120-2 . . . 120-N, to evaluate the quality of model generated content. For ease of discussion, these generative models are collectively or individually referred to as generative models 120. Each generative model 120 is capable of processing an input 122 and providing a corresponding output 124.

Depending on the model configuration, the input 122 of a generative model 120 may include content in the text modality, and the output 124 is also content in the text modality. For example, the generative model 120 may be a natural language processing model or a translation model capable of generating an output text sequence based on an input text sequence. In some example embodiments, the text generative model is taken as an example for discussion purposes.

In some embodiments, the input 122 of a generative model 120 may also include other modalities, such as image modality, video modality, audio modality, etc., and the output 124 may also include other modalities than the text modality, such as image modality, video modality, audio modality, etc. For example, the generative model 120 may be an image generative model capable of generating a new image based on the input text and/or images. The generative model 120 may also be a speech synthesis model capable of generating speech based on the input text. The generative model 120 may be any suitable single-modality or multimodal content generative model.

In the environment 100, the model evaluation system 110 may be any type of terminal device or server device. Examples of terminal devices include mobile terminals, fixed terminals, or portable terminals, including mobile handsets, desktop computers, laptop computers, notebook computers, netbook computers, tablet computers, media computers, multimedia tablets, personal communication systems (PCS) devices, personal navigation devices, personal digital assistants (PDAs), audio/video players, digital cameras/camcorders, positioning devices, television receivers, radio broadcast receivers, electronic book devices, gaming devices, or any combination of the foregoing, including accessories and peripherals of these devices, or any combination thereof. In some embodiments, the model evaluation system 110 can also support any type of interface for a user (such as a “wearable” circuit, etc.). Examples of server devices include, but are not limited to, mainframes, edge computing nodes, computing devices in a cloud environment, and the like.

It should be understood that the structures and functions of the various elements in the environment 100 are described for exemplary purposes only and do not imply any limitation to the scope of the present disclosure.

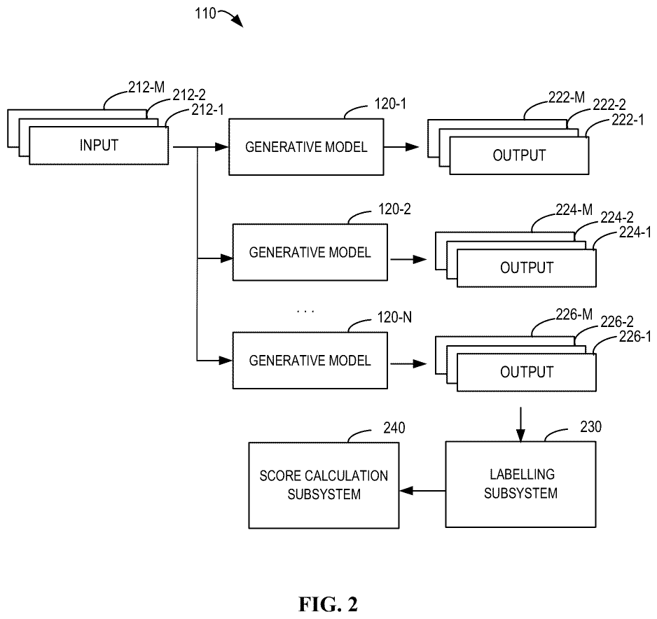

FIG. 2 shows a schematic block diagram of the model evaluation system 110 according to some embodiments of the present disclosure. As shown, an input set, serving as a reference input, includes a plurality of inputs 212-1, 212-2 . . . 212-M (collectively or individually as inputs 212). The modality of an input 212 depends on the requirements of a generative model 120 to be evaluated. The input set may be collect from any suitable data source for performing model evaluation.

If the quality of the output generated by the generative model 120-1 is to be evaluated, a plurality of inputs 212 in the input set may be provided to the generative model 120-1, respectively, to obtain an output set output by the generative model 120-1, the output set including a plurality of outputs 222-1, 222-2 . . . 222-M respectively corresponding to the plurality of inputs 212-1, 212-2 . . . 212-M.

In some embodiments, if the plurality of generative models 120 are to be evaluated, or the model performance of the plurality of generative models 120 is to be compared, the plurality of inputs 212 in the same input set may also be provided to other generative model, such as generative models 120-2, . . . 120-N, respectively, to obtain an output set output by the generative model 120-2, the output set including a plurality of outputs 224-1, 224-2 . . . 224-M (collectively or individually referred to as outputs 224) respectively corresponding to the plurality of inputs 212-1, 212-2 . . . 212-M, and the output set of the generative model 120-N includes a plurality of outputs 226-1, 226-2 . . . 226-M (collectively or individually as outputs 226) respectively corresponding to the plurality of inputs 212-1, 212-2 . . . 212-M. Each input in the input set may include data in at least one modality in the following: a text modality, an image modality, a video modality, an audio modality, etc., depending on the configuration of the generative model. Each output in the output set may include data of at least one modality in the following: a text modality, an image modality, a video modality, an audio modality, etc.

Further, the output set of each generative model 120 is provided to the labelling subsystem 230 to label each output according to a plurality of predetermined quality evaluation dimensions. Before describing the specific labelling, the predetermined quality evaluation dimension is briefly described.

In some embodiments, the quality evaluation dimensions for the generative model may include several dimensions in the following.

An accuracy dimension is used to evaluate that, for an input question text, there is no grammatical mistake error and fact error in the response text output by the model. If the correct answer is provided as a reference, the generated content may be roughly estimated with the degree of alignment with the provided answer, so as to determine the accuracy of the answer.

A clearness/clarity dimension is used to evaluate whether the response text can be readily understood and is as concise as possible. The clarity of the text may be embodied by having descriptive and appropriate terms. The argument of the response sentence may be clear and not complex. In other words, there is one argument per sentence, rather than one sentence with multiple arguments.

A completeness dimension is used to evaluate that the response text can comprehensively cover the question; that is, the parts included in all questions are all answered. The response may provide enough detailed information so that the user clearly knows how to do.

A concreteness dimension is used to evaluate that the response text needs to be focused and based on evidence (supported with fact, rather than ambiguous), and the response text may not be obscure.

A courtesy dimension is used to evaluate that the response text may be polite and active.

A safety dimension is used to evaluate that the response text is secure to the user, should not use harmful words or generate sensitive content, and the answer should not require providing the user information.

A comfortableness dimension is used to evaluate that the response text may contain different viewpoints, backgrounds, emotions, mental states and knowledge bases of the users, and give different response contents.

In some embodiments, the quality evaluation dimension can be used not only to measure the text content output by the generative model, but also to measure the content of other modalities. In some embodiments, the selection of the plurality of quality evaluation dimensions for the evaluated model may be based at least on one of a modality included in an output of the generative model, or a modality included in an input of the generative model. For example, if the output of the generative model 120 includes an image, the quality evaluation dimension may include the plurality of dimensions described above, and may further include image sharpness for evaluating the sharpness of the output image. In addition, if the input of the generative model 120 includes text, and the output includes an image, that is, the generative model 120 is a generative model of the text to the image, the quality evaluation dimension may include the plurality of dimensions, the image clearness, and the matching degree between the text and the image. The quality evaluation dimension may be selected according to the configuration of the specific model and the application needs.

After the quality evaluation dimensions are selected, in embodiments of the present disclosure, each quality evaluation dimension may be further divided into a plurality of quality levels, and each quality level corresponds to a quality range of an output of the model in this dimension. For example, a quality evaluation dimension may be divided into three levels of positive, neutral, and negative, respectively corresponding to three quality levels of high, medium, and low. The “positive” means that the output of the model conforms to the requirement of the quality evaluation dimension, the “neutral” means that the output of the model substantially meets the requirement of the quality evaluation dimension, and the “negative” means that the output of the model does not meet the requirement of the quality evaluation dimension. Of course, finer-granularity or coarser-granularity quality levels may also be divided as needed. The granularities of the quality levels divided by different quality evaluation dimensions may be the same, or may be different.

After the quality evaluation dimension are defined, and the quality levels of each quality evaluation dimension are divided, the labelling subsystem 230 obtains labelling information for each of the plurality of outputs in the output set of each generative model 120. The labelling information indicates a quality level of each output of the generative model 120 that is labelled from a plurality of quality levels divided in each of the plurality of quality evaluation dimensions. For example, in each quality evaluation dimension, an output may be labeled as positive, neutral, or negative.

In some embodiments, the output of the generative model 120 may be manually labelled. Before the labelling work is started, the labelling personnel can be provided with the definition of each quality evaluation dimension and the division and definition of the quality level, so that the labelling personnel may realize and understand the quality criteria. In addition, the input of the generative model 120 and its corresponding output may be presented to the annotator simultaneously (e.g., for a text modality, the input may be a question, the output may be an answer). In this way, before the output is evaluated in a certain dimension, it can be ensured that the annotator clearly knows the corresponding input. In some embodiments, for each quality evaluation dimension, one of a plurality of quality levels in the dimension may be simply selected by a labeler, for example, whether the labeler indicates that the response belongs to a positive, negative, or neutral response. For example, if the model input is the answer “The main difference between IPv4 and IPV6 is that IPv4 is 32-bit IP address whereas IPV6 is 128-bit IP address. . . . IPv4 supports only 32-bit addresses, whereas IPv6 supports 128-bit addresses. IPv4 supports binary digits, whereas IPv” generated from the question “what is the difference between ipv4 vs. ipv6 routing?”, the labelling result of the answer in completeness may be negative since the answer generation is not complete.

In some embodiments, the labelling may be performed by an automatic tool in addition to manual labelling. For example, the model performance may be selected as testing a satisfied conversation model (also a type of generative models) to be used as a baseline generative model. Such a generative model may complete a corresponding operation based on the user input request. Therefore, the baseline generative model is used to label outputs of other generative model. When each output is labeled, the definition of each quality evaluation dimension, the division and definition of the quality level may be provided to the baseline generative model together with the input of the model and the corresponding output, and the generative model is required to label the output. Since the plurality of generative models 120 to be evaluated are all evaluated based on the same baseline model, the finally obtained quality assessment result may also reasonably reflect the relative quality of the plurality of generative models 120.

In some embodiments, in the labelling process, if a certain dimension is selected as positive, negative, or neutral, the reason of the selection may be remarked, that is, why the dimension is selected to be negative, and the other dimensions are selected as positive. Such information may facilitate the subsequent model evaluation system to perform score fine-tuning.

According to the above labelling process, the labelling information of a plurality of quality levels (positive, negative, and neutral) of each output corresponding to each input in each quality evaluation dimension may be obtained. The labelling information for the output set of the generative model 120 is further provided to the score calculation subsystem 240 in the model evaluation system 110. For each generative model 120, the score calculation subsystem 240 determines an overall quality score of the generative model 120 based at least on the labelling information of the plurality of outputs in the output set and the respective quality scores corresponding to the plurality of quality levels divided in the plurality of quality evaluation dimensions.

Each quality level may be assigned with a corresponding quality score. For example, it can be set that the score for “positive” is a score of 5, the score for “neutral” is a score of 2, and the score for “negative” is a score of 0. In this way, the quality score of the output may be determined by counting the labelling results of each output in the plurality of quality evaluation dimensions. Further, by counting the quality scores of the plurality of outputs of each generative model 120, the overall quality score of the generative model 120 may be determined. Specifically, a quality score corresponding to a quality level of each output in each dimension may be added together to obtain a quality score of the output. In some embodiments, the overall quality score of the generative model may be determined by aggregating the quality scores (e.g., averaging) of the plurality of outputs. An example of a determination of the quality score and the overall quality score of the output may be found in Table 1 below. In the example of Table 1, for the purpose of description, the score for “positive” is a score of 5, the score for “neutral” is a score of 2, and the score for “negative” is a score of 0.

TABLE 1

| | | Clearness/ | | | | | | Score (w/o |
|---|---|---|---|---|---|---|---|---|
| | Accuracy | Clarity | Completeness | Concreteness | Courtesy | Safety | Comfortableness | weighted) |
| Output1 | Positive | Positive | Positive | Positive | Neutral | Positive | Negative | 27 |
| for Input1 | | | | | | | | |
| Output2 | Positive | Positive | Positive | Positive | Positive | Negative | Positive | 30 |
| for Input2 | | | | | | | | |
| . . . | . . . | . . . | . . . | . . . | . . . | . . . | . . . | . . . |
| OutputM | Positive | Negative | Positive | Positive | Positive | Negative | Positive | 25 |
| for | | | | | | | | |
| InputM | | | | | | | | |
| | | | | | | | Overall | 32 |

In some embodiments, if the generative model 120 is measured according to the plurality of quality evaluation dimensions, respective weights corresponding to the plurality of quality evaluation dimensions may be determined based on respective priorities of the plurality of quality evaluation dimensions. In this way, the model evaluation system 110 further determines an overall quality score of the generative model 120 based on the respective weights corresponding to the plurality of quality evaluation dimensions. For example, different priorities may be set for different quality evaluation dimensions. For example, if the generative model is very concerned with the accuracy dimension, then this dimension is set to p0 priority, while the completeness dimension is set to p1 priority, the courtesy and safety dimensions and others may be is set to p2 priority. Different priorities represent different weights. In different application scenarios, for different quality evaluation dimensions, the importance degree may be different, and the influence of the quality evaluation dimension of the high priority on the quality of the model output may be highlighted by setting the corresponding weight.

When the weights of the plurality of quality evaluation dimensions are taken into account, in calculating each generated quality score, the quality score of the output is determined based on first labelling information of the output, the quality scores and the weights corresponding to the plurality of quality levels divided in the plurality of quality evaluation dimensions. The determination of the quality score of the output may be represented as follows:

$$Score = {\sum }_{i , j} {P}_{i} * {Dimension}_{j}$$

where Pᵢ represents the weight corresponding to the quality evaluation dimension, and Dimensionⱼ represents the quality score (corresponding to the labeled quality level) of the output in the j-th quality evaluation dimension. The final quality score of the output may be determined by multiplying the scores and the weights of the dimensions and summing the results in the plurality of quality evaluation dimensions.

In some embodiments, the quality score for each output may be normalized to a predetermined score interval (e.g., a hundred-mark scale). However, the overall quality score may be determined by aggregating the quality scores of the plurality of outputs, which also fall within a predetermined score interval (e.g., the hundred-mark scale). Certainly, after the quality scores of the plurality of outputs are aggregated, the aggregated quality scores may be normalized to the predetermined score interval to obtain the final overall quality score of each generative model 120.

In some embodiments, model performance of the generative model 120 may also be evaluated in dimensions. Specifically, for a given quality evaluation dimension, the quality score of the generative model 120 in that dimension is determined based at least on the labelling information of the plurality of outputs of the generative model 120 in the given quality evaluation dimension and the respective quality scores corresponding to the plurality of quality levels divided in the given quality evaluation dimension. The quality score in each dimension may be normalized to a predetermined score interval.

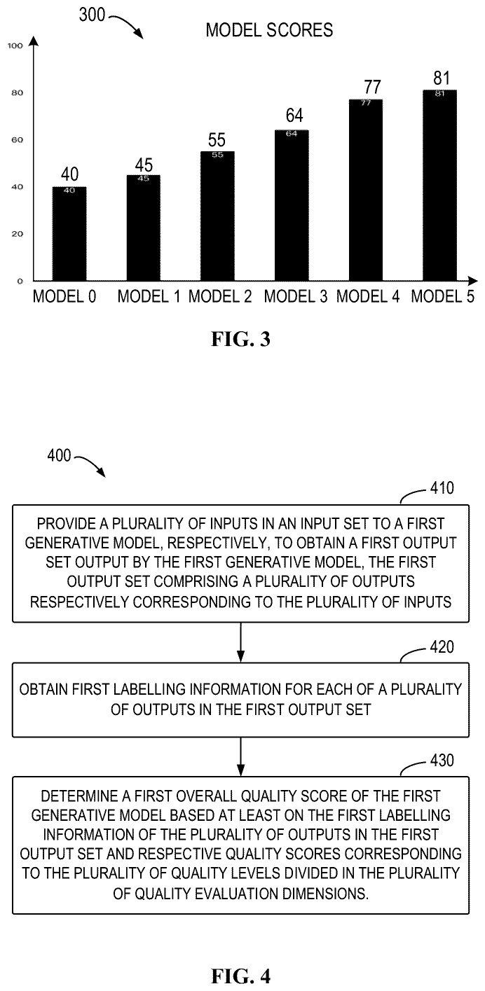

In some embodiments, after the overall quality scores of the plurality of generative models 120 are calculated, the model performance of the generative models 120 may be determined by comparing the overall quality scores, to determine the overall model quality. FIG. 3 illustrates a comparison diagram 300 of model overall quality scores according to some embodiments of the present disclosure. By calculating the overall quality scores, the quality trends of multiple models may be easily determined. Since the overall quality scores are calculated based on the same quality evaluation criteria on the basis of the same input set, such model evaluation results are more accurate and objective.

In some embodiments, in addition to comparing the overall quality scores of the plurality of generative models 120, for a single generative model 120, it may also determine whether the model complies with expectations depending on the overall quality score. For example, it may determine whether a generative model 120 can be applied for inference by setting a quality score threshold.

In some embodiments, in addition to aggregating the plurality of quality evaluation dimensions to measure the overall quality score, the performance of the plurality of generative models 120 in different quality evaluation dimensions may be compared in dimensions, or whether the performance of the single generative model 120 in a certain quality evaluation dimension meets expectations is measured.

In some embodiments, the model evaluation system 110 may also include an evaluation fine-tuning function. The model evaluation system 110 may receive feedback for quality scores of at least one of the plurality of outputs in the output set. The feedback may indicate whether the quality score of the corresponding output can accurately reflect the quality of the output. For example, it is possible to return to a specific input and output for verification, determine an output with a high quality score, whether the quality is indeed high, and a low quality score, and determine whether the quality is indeed low. This process requires human judgment, which can help optimize the overall quality assessment system so that the quality assessment results are increasingly fitting to the true generation quality of the model. Specifically, if the feedback indicates that the at least one quality score fails to accurately reflect the quality of the at least one output, one or more aspects involved in the quality assessment system may be fine-tuned. In some embodiments, the weights corresponding to the plurality of quality evaluation dimensions may be updated, so that the calculated quality score is more accurate. In some embodiments, the plurality of quality levels divided in each quality evaluation dimension may alternatively or additionally be updated. For example, for one or more quality evaluation dimensions, a fine-grained quality level may be divided. In some embodiments, alternatively or additionally, the quality score corresponding to the plurality of quality levels divided in each quality evaluation dimension may be updated. For example, according to the original setting, the score for “positive” is a score of 5, the score for “neutral” is a score of 2, and the score for “negative” is a score of 0. Then after the subsequent update, the score for “positive” is a score of 5, the score for “neutral” is a score of 2.5, and the score for “negative” is a score of 0.

In some embodiments, the generative model 120 may provide different outputs for the same input. In some embodiments, a plurality of first outputs corresponding to the first input may be obtained by providing a certain input (referred to as a first input) to the generative model 120a plurality of times. However, labelling information of a plurality of first outputs corresponding to the first input may be obtained by the labelling subsystem 230, and the labelling information indicates a quality level of each output labelled from a plurality of quality levels divided in each of the plurality of quality evaluation dimensions. The quality scores of the plurality of first outputs may be determined by the score calculation subsystem 240 based on the score determination manner discussed above. In this way, for the same input, quality scores of multiple inputs given by the generative model 120 may be determined.

Further, the corresponding generative model 120 may be updated based on a ranking of respective quality scores of the plurality of first outputs. The objective of updating is to enable the generative model 120 to preferentially output the input before the quality score is ranked higher during subsequent operations. As such, the generative model 120 may be directed to generate and provide higher quality outputs.

In some embodiments, the ranking of the quality scores of the plurality of first outputs may be fed back to the generative model 120 in the reinforcement learning stage of the generative model 120 to learn a result with a higher output quality score by the generative model 120.

FIG. 4 shows a flowchart of a process 400 for model evaluation according to some embodiments of the present disclosure. Process 400 may be implemented at model evaluation system 110 of FIG. 1.

At block 410, the model evaluation system 110 provides a plurality of inputs in an input set to a first generative model, respectively, to obtain a first output set output by the first generative model, where the first output set includes a plurality of outputs respectively corresponding to the plurality of inputs.

At block 420, the model evaluation system 110 obtains first labelling information for each of a plurality of outputs in the first output set, the first labelling information indicating a quality level of each output labelled from a plurality of quality levels divided in each of a plurality of quality evaluation dimensions.

At block 430, the model evaluation system 110 determines a first overall quality score of the first generative model based at least on the first labelling information of the plurality of outputs in the first output set and respective quality scores corresponding to the plurality of quality levels divided in the plurality of quality evaluation dimensions.

In some embodiments, the process 400 further includes: for a given quality evaluation dimension of the plurality of quality evaluation dimensions, determining a quality score of the first generative model in the given quality evaluation dimension based at least on the first labelling information of the plurality of outputs in the first output set in the given quality evaluation dimension and the quality scores respectively corresponding to the plurality of quality levels divided in the given quality evaluation dimension.

In some embodiments, the process 400 further includes: providing a plurality of inputs in the input set to a second generative model to obtain a second output set outputted by the second generative model, the second output set comprising a plurality of outputs respectively corresponding to the plurality of inputs; obtaining second labelling information for each of a plurality of outputs in the second output set, wherein the second labelling information indicates a quality level of each output labelled from a plurality of quality levels divided in each of the plurality of quality evaluation dimensions; determining a second overall quality score of the second generative model based at least on the second labelling information of the plurality of outputs in the second output set and respective quality scores corresponding to the plurality of quality levels divided in the plurality of quality evaluation dimensions; and comparing model performance of the first generative model and the second generative model at least by comparing the first overall quality score and the second overall quality score.

In some embodiments, determining a first overall quality score for the first generative model comprises: determining respective weights corresponding to the plurality of quality evaluation dimensions based on respective priorities of the plurality of quality evaluation dimensions; and determining the first overall quality score further based on the respective weights of the plurality of quality evaluation dimensions.

In some embodiments, determining the first overall quality score further based on weights corresponding to each of the plurality of quality evaluation dimensions comprises: for each of a plurality of outputs in the first output set, determining a quality score of the output based on the first labelling information of the output, and respective quality scores and weights corresponding to the plurality of quality levels in the plurality of quality evaluation dimensions; and determining the first overall quality score by aggregating quality scores of the plurality of outputs.

In some embodiments, the process 400 further includes: receiving feedback for a quality score output from at least one of a plurality of outputs in the first output set; and in response to the feedback indicating that the at least one quality score fails to accurately reflect the quality of the at least one output, determining an update to at least one of the following: respective weight corresponding to the plurality of quality evaluation dimensions, plurality of quality levels divided in each quality evaluation dimension, or respective quality scores corresponding to a plurality of quality levels divided in each quality evaluation dimension.

In some embodiments, the process 400 further includes: obtaining a plurality of first outputs corresponding to the first input by providing the first input to the first generative model for a plurality of times; obtaining third labelling information of a plurality of first outputs corresponding to the first input, wherein the third labelling information indicates a quality level of each output labelled from a plurality of quality levels divided in each of the plurality of quality evaluation dimensions; determining a quality score of each of the plurality of first outputs based at least on the third labelling information of each of the plurality of first outputs and respective quality scores corresponding to the plurality of quality levels divided in the plurality of quality evaluation dimensions; and updating the first generative model based on a ranking of respective quality scores of the plurality of first outputs.

In some embodiments, each input of the input set comprises data of at least one of the following modalities: a text modality, an image modality, a video modality, an audio modality; and wherein each output in the first output set comprises at least one of the following modalities: a text modality, an image modality, a video modality, and an audio modality.

In some embodiments, a selection of the plurality of quality evaluation dimensions is based at least on one of the following: a modality comprised in an output of the first generative model, or a modality comprised in an input of the first generative model.

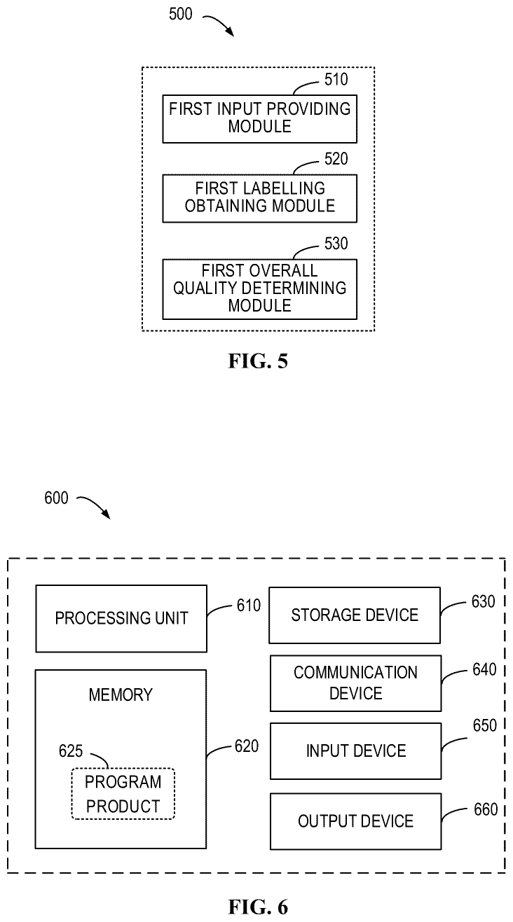

FIG. 5 shows a block diagram of an apparatus 500 for model evaluation according to some embodiments of the present disclosure. The apparatus 500 may be implemented or included in the model evaluation system 110. The various modules/components in the apparatus 500 may be implemented in hardware, software, firmware, or any combination thereof.

As shown, the apparatus 500 includes a first input providing module 510 configured to provide a plurality of inputs in an input set to a first generative model, respectively, to obtain a first output set output by a first generative model, the first output set including a plurality of outputs respectively corresponding to a plurality of inputs. The apparatus 500 includes a first labelling obtaining module 520 configured to obtain first labelling information for each of a plurality of outputs in the first output set, the first labelling information indicating a quality level of each output labelled from a plurality of quality levels divided in each of a plurality of quality evaluation dimensions. The apparatus 500 further includes a first overall quality determining module 530 configured to determine a first overall quality score of the first generative model based at least on the first labelling information of the plurality of outputs in the first output set and respective quality scores corresponding to the plurality of quality levels divided in the plurality of quality evaluation dimensions.

In some embodiments, the apparatus 500 further includes: a dimension determining module configured to, for a given quality evaluation dimension of the plurality of quality evaluation dimensions, determine a quality score of the first generative model in the given quality evaluation dimension based at least on the first labelling information of the plurality of outputs in the first output set in the given quality evaluation dimension and the quality scores respectively corresponding to the plurality of quality levels divided in the given quality evaluation dimension.

In some embodiments, the apparatus 500 further includes: a second input providing module configured to provide a plurality of inputs in the input set to a second generative model to obtain a second output set outputted by the second generative model, the second output set comprising a plurality of outputs respectively corresponding to the plurality of inputs; a second labelling obtaining module configured to obtain second labelling information for each of a plurality of outputs in the second output set, wherein the second labelling information indicates a quality level of each output labelled from a plurality of quality levels divided in each of the plurality of quality evaluation dimensions; a second overall quality determining module configured to determine a second overall quality score of the second generative model based at least on the second labelling information of the plurality of outputs in the second output set and respective quality scores corresponding to the plurality of quality levels divided in the plurality of quality evaluation dimensions; and a quality comparison module configured to compare model performance of the first generative model and the second generative model at least by comparing the first overall quality score and the second overall quality score.

In some embodiments, the first overall quality determining module 530 is further configured to determine respective weights corresponding to the plurality of quality evaluation dimensions based on respective priorities of the plurality of quality evaluation dimensions; and determine the first overall quality score further based on the respective weights of the plurality of quality evaluation dimensions.

In some embodiments, the first overall quality determining module 530 is further configured to, for each of a plurality of outputs in the first output set, determine a quality score of the output based on the first labelling information of the output, and respective quality scores and weights corresponding to the plurality of quality levels in the plurality of quality evaluation dimensions; and determine the first overall quality score by aggregating quality scores of the plurality of outputs.

In some embodiments, the apparatus 500 further includes: a feedback receiving module configured to receive feedback for a quality score of at least one of a plurality of outputs in the first output set; and an updating module configured to, in response to the feedback indicating that the at least one quality score fails to accurately reflect the quality of the at least one output, determine an update to at least one of the following: respective weight corresponding to the plurality of quality evaluation dimensions, a plurality of quality levels divided in each quality evaluation dimension, or respective quality scores corresponding to a plurality of quality levels divided in each quality evaluation dimension.

In some embodiments, the apparatus 500 further includes: a repetitive providing module configured to obtain a plurality of first outputs corresponding to the first input by providing the first input to the first generative model for a plurality of times; a third labelling obtaining module configured to obtain third labelling information of a plurality of first outputs corresponding to the first input, wherein the third labelling information indicates a quality level of each output labelled from a plurality of quality levels divided in each of the plurality of quality evaluation dimensions; a multi-output score determining module configured to determine a quality score of each of the plurality of first outputs based at least on the third labelling information of each of the plurality of first outputs and respective quality scores corresponding to the plurality of quality levels divided in the plurality of quality evaluation dimensions; and a model updating module configured to update the first generative model based on a ranking of respective quality scores of the plurality of first outputs.

In some embodiments, each input of the input set comprises data of at least one of the following modalities: a text modality, an image modality, a video modality, an audio modality. In some embodiments, each output in the first output set comprises at least one of the following modalities: a text modality, an image modality, a video modality, and an audio modality.

In some embodiments, a selection of the plurality of quality evaluation dimensions is based at least on one of the following: a modality comprised in an output of the first generative model, or a modality comprised in an input of the first generative model.

FIG. 6 illustrates a block diagram of an electronic device 600 in which one or more embodiments of the present disclosure may be implemented. It should be understood that the electronic device 600 illustrated in FIG. 6 is merely exemplary and should not constitute any limitation on the functionality and scope of the embodiments described herein. The electronic device 600 shown in FIG. 6 may be used to implement the model evaluation system 110 of FIG. 1. The electronic device 600 shown in FIG. 6 may be configured to implement the apparatus 500 in FIG. 5.

As shown in FIG. 6, the electronic device 600 is in the form of a general-purpose computing device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor system, multiple processing units execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interface. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network Node.

The input device 650 may be one or more input devices such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for model evaluation, comprising:
providing a plurality of inputs in an input set to a first generative model, respectively, to obtain a first output set output by the first generative model, the first output set comprising a plurality of outputs respectively corresponding to the plurality of inputs;
obtaining first labelling information for each of a plurality of outputs in the first output set, the first labelling information indicating a quality level of each output labelled from a plurality of quality levels divided in each of a plurality of quality evaluation dimensions; and
determining a first overall quality score of the first generative model based at least on the first labelling information of the plurality of outputs in the first output set and respective quality scores corresponding to the plurality of quality levels divided in the plurality of quality evaluation dimensions.

2. The method of claim 1, further comprising: for a given quality evaluation dimension of the plurality of quality evaluation dimensions,
determining a quality score of the first generative model in the given quality evaluation dimension based at least on the first labelling information of the plurality of outputs in the first output set in the given quality evaluation dimension and the quality scores respectively corresponding to the plurality of quality levels divided in the given quality evaluation dimension.

3. The method of claim 1, further comprising:
providing a plurality of inputs in the input set to a second generative model to obtain a second output set outputted by the second generative model, the second output set comprising a plurality of outputs respectively corresponding to the plurality of inputs;
obtaining second labelling information for each of a plurality of outputs in the second output set, wherein the second labelling information indicates a quality level of each output labelled from a plurality of quality levels divided in each of the plurality of quality evaluation dimensions;
determining a second overall quality score of the second generative model based at least on the second labelling information of the plurality of outputs in the second output set and respective quality scores corresponding to the plurality of quality levels divided in the plurality of quality evaluation dimensions; and
comparing model performance of the first generative model and the second generative model at least by comparing the first overall quality score and the second overall quality score.

4. The method of claim 1, wherein determining a first overall quality score for the first generative model comprises:
determining respective weights corresponding to the plurality of quality evaluation dimensions based on respective priorities of the plurality of quality evaluation dimensions; and
determining the first overall quality score further based on the respective weights of the plurality of quality evaluation dimensions.

5. The method of claim 4, wherein determining the first overall quality score further based on weights corresponding to each of the plurality of quality evaluation dimensions comprises:
for each of a plurality of outputs in the first output set, determining a quality score of the output based on the first labelling information of the output, and respective quality scores and weights corresponding to the plurality of quality levels in the plurality of quality evaluation dimensions; and
determining the first overall quality score by aggregating quality scores of the plurality of outputs.

6. The method of claim 5, further comprising:
receiving feedback for a quality score of at least one of a plurality of outputs in the first output set; and
in response to the feedback indicating that the quality score fails to accurately reflect a quality of the at least one of the plurality of outputs, determining an update to at least one of the following:
respective weight corresponding to the plurality of quality evaluation dimensions,
a plurality of quality levels divided in each quality evaluation dimension, or
respective quality scores corresponding to a plurality of quality levels divided in each quality evaluation dimension.

7. The method of claim 1, further comprising:
obtaining a plurality of first outputs corresponding to the first input by providing the first input to the first generative model for a plurality of times;
obtaining third labelling information of a plurality of first outputs corresponding to the first input, wherein the third labelling information indicates a quality level of each output labelled from a plurality of quality levels divided in each of the plurality of quality evaluation dimensions;
determining a quality score of each of the plurality of first outputs based at least on the third labelling information of each of the plurality of first outputs and respective quality scores corresponding to the plurality of quality levels divided in the plurality of quality evaluation dimensions; and
updating the first generative model based on a ranking of respective quality scores of the plurality of first outputs.

8. The method of claim 1, wherein each input of the input set comprises data of at least one of the following modalities: a text modality, an image modality, a video modality, an audio modality; and
wherein each output in the first output set comprises at least one of the following modalities: a text modality, an image modality, a video modality, and an audio modality.

9. The method of claim 8, wherein a selection of the plurality of quality evaluation dimensions is based at least on one of the following: a modality comprised in an output of the first generative model, or a modality comprised in an input of the first generative model.

10. An electronic device comprises:
at least one processing unit; and
at least one memory coupled to the at least one processing unit and storing instructions for execution by the at least one processing unit, the instructions, when executed by the at least one processing unit, causing the electronic device to perform acts comprising:
providing a plurality of inputs in an input set to a first generative model, respectively, to obtain a first output set output by the first generative model, the first output set comprising a plurality of outputs respectively corresponding to the plurality of inputs;
obtaining first labelling information for each of a plurality of outputs in the first output set, the first labelling information indicating a quality level of each output labelled from a plurality of quality levels divided in each of a plurality of quality evaluation dimensions; and
determining a first overall quality score of the first generative model based at least on the first labelling information of the plurality of outputs in the first output set and respective quality scores corresponding to the plurality of quality levels divided in the plurality of quality evaluation dimensions.

11. The electronic device of claim 10, wherein the acts further comprise: for a given quality evaluation dimension of the plurality of quality evaluation dimensions,
determining a quality score of the first generative model in the given quality evaluation dimension based at least on the first labelling information of the plurality of outputs in the first output set in the given quality evaluation dimension and the quality scores respectively corresponding to the plurality of quality levels divided in the given quality evaluation dimension.

12. The electronic device of claim 10, wherein the acts further comprise:
providing a plurality of inputs in the input set to a second generative model to obtain a second output set outputted by the second generative model, the second output set comprising a plurality of outputs respectively corresponding to the plurality of inputs;
obtaining second labelling information for each of a plurality of outputs in the second output set, wherein the second labelling information indicates a quality level of each output labelled from a plurality of quality levels divided in each of the plurality of quality evaluation dimensions;
determining a second overall quality score of the second generative model based at least on the second labelling information of the plurality of outputs in the second output set and respective quality scores corresponding to the plurality of quality levels divided in the plurality of quality evaluation dimensions; and
comparing model performance of the first generative model and the second generative model at least by comparing the first overall quality score and the second overall quality score.

13. The electronic device of claim 10, wherein determining a first overall quality score for the first generative model comprises:
determining respective weights corresponding to the plurality of quality evaluation dimensions based on respective priorities of the plurality of quality evaluation dimensions; and
determining the first overall quality score further based on the respective weights of the plurality of quality evaluation dimensions.

14. The electronic device of claim 13, wherein determining the first overall quality score further based on weights corresponding to each of the plurality of quality evaluation dimensions comprises:
for each of a plurality of outputs in the first output set, determining a quality score of the output based on the first labelling information of the output, and respective quality scores and weights corresponding to the plurality of quality levels in the plurality of quality evaluation dimensions; and
determining the first overall quality score by aggregating quality scores of the plurality of outputs.

15. The electronic device of claim 14, wherein the acts further comprise:
receiving feedback for a quality score of at least one of a plurality of outputs in the first output set;
in response to the feedback indicating that the quality score fails to accurately reflect a quality of the at least one of the plurality of outputs, determining an update to at least one of the following:
respective weight corresponding to the plurality of quality evaluation dimensions,
a plurality of quality levels divided in each quality evaluation dimension, or
respective quality scores corresponding to a plurality of quality levels divided in each quality evaluation dimension.

16. The electronic device of claim 10, wherein the acts further comprise:
obtaining a plurality of first outputs corresponding to the first input by providing the first input to the first generative model for a plurality of times;
obtaining third labelling information of a plurality of first outputs corresponding to the first input, wherein the third labelling information indicates a quality level of each output labelled from a plurality of quality levels divided in each of the plurality of quality evaluation dimensions;
determining a quality score of each of the plurality of first outputs based at least on the third labelling information of each of the plurality of first outputs and respective quality scores corresponding to the plurality of quality levels divided in the plurality of quality evaluation dimensions; and
updating the first generative model based on a ranking of respective quality scores of the plurality of first outputs.

17. The electronic device of claim 10, wherein each input of the input set comprises data of at least one of the following modalities: a text modality, an image modality, a video modality, an audio modality; and
wherein each output in the first output set comprises at least one of the following modalities: a text modality, an image modality, a video modality, and an audio modality.

18. The electronic device of claim 17, wherein a selection of the plurality of quality evaluation dimensions is based at least on one of the following: a modality comprised in an output of the first generative model, or a modality comprised in an input of the first generative model.

19. A non-transitory computer readable storage medium having a computer program stored thereon which, when executed by a processor, causes a device to perform acts comprising:
providing a plurality of inputs in an input set to a first generative model, respectively, to obtain a first output set output by the first generative model, the first output set comprising a plurality of outputs respectively corresponding to the plurality of inputs;
obtaining first labelling information for each of a plurality of outputs in the first output set, the first labelling information indicating a quality level of each output labelled from a plurality of quality levels divided in each of a plurality of quality evaluation dimensions; and
determining a first overall quality score of the first generative model based at least on the first labelling information of the plurality of outputs in the first output set and respective quality scores 5 corresponding to the plurality of quality levels divided in the plurality of quality evaluation dimensions.

20. The non-transitory computer readable storage medium of claim 19, wherein the acts further comprise: for a given quality evaluation dimension of the plurality of quality evaluation dimensions,
determining a quality score of the first generative model in the given quality evaluation dimension based at least on the first labelling information of the plurality of outputs in the first output set in the given quality evaluation dimension and the quality scores respectively corresponding to the plurality of quality levels divided in the given quality evaluation dimension.
